(19) United States
(12) Patent Application Publication
(10) Pub. No.: US 2025/0103540 A1
(43) Pub. Date: Mar. 27, 2025

(54) DETECTION OF A STOP CONDITION ASSERTED BY A TARGET ON A SERIAL DATA BUS

(71) Applicant: MICROCHIP TECHNOLOGY INCORPORATED, Chandler, AZ (US)

(72) Inventor: Robin Jonah Solomon, Chennai (IN)

(21) Appl. No.: 18/538,689

(22) Filed: Dec. 13, 2023

(30) Foreign Application Priority Data
Sep. 21, 2023 (IN) 202341063371

(51) Int. Cl. G06F 13/42

(52) U.S. Cl. CPC G06F 13/4282

(57) ABSTRACT

A controller is provided that includes a serial data (SDA) line interface to connect the controller to an SDA line of a two-wire, shared, serial data bus. The controller includes processing circuitry to transfer output data on the SDA line, and monitor the SDA line of the data bus while the output data is transferred on the SDA line of the two-wire, shared, serial data bus. The controller detects a stop condition asserted by a target on the data bus while the output data is transferred on the SDA line of the two-wire, shared, serial data bus. The controller then ends transfer of the output data on the SDA line, in response to the detected stop condition.

### CROSS-REFERENCE TO RELATED APPLICATION(S)

The present application claims priority to Indian Provisional Patent Application No. 20/234,1063371, entitled: Detection and Recovery from a Conflict on a Serial Data Bus, filed on Sep. 21, 2023; and the present application is related to U.S. patent application Ser. No. 18/514,759, entitled: Detection and Recovery from an Error Condition on a Serial Data Bus, filed on Nov. 20, 2023, the contents of both of which are hereby incorporated by reference in their entireties.

### TECHNOLOGICAL FIELD

The present disclosure relates generally to serial communication and, in particular, to detection of a stop condition asserted by a target on a serial data bus.

### BACKGROUND

Serial communication has played a significant role in facilitating inter-chip communication within electronic systems. It involves the transmission of data sequentially, bit by bit, over a communication link between devices. This approach offers advantages such as simplicity, low pin count, and the ability to transmit data over longer distances compared to parallel communication.

One popular serial communication protocol is I2C (Inter-Integrated Circuit), which was developed by Philips Semiconductor (now NXP Semiconductors) in the early 1980s. I2C is a two-wire bus protocol that allows multiple devices to communicate with each other using a shared serial data (SDA) line and serial clock (SCL) line. It supports a controller-target (master-slave) architecture where a controller device initiates and controls communication, and target devices respond to the controller's commands or requests. I2C is commonly used for connecting various devices in embedded systems, consumer electronics, and computer peripherals.

As technology advanced and the need for higher data transfer rates, increased flexibility, and improved power efficiency emerged, the MIPI Alliance developed I3C (Improved Inter-Integrated Circuit). Introduced in 2017, I3C builds upon the strengths of I2C while offering enhancements and additional features. I3C is backward compatible with I2C, allowing I2C devices to coexist on the same data bus. It introduces higher data transfer rates, increased flexibility for connecting multiple devices, multi-controller support, hot-join capability, dynamic address assignment, in-band interrupts, and other improvements. I3C has gained popularity in applications such as smartphones, tablets, Internet of Things (IoT) devices, and automotive systems.

Serial communication protocols like I2C and I3C have become integral to inter-chip communication within electronic systems. They enable devices to exchange data, commands, and control signals efficiently and reliably. These protocols have been widely adopted and standardized, allowing for interoperability between devices from different manufacturers and simplifying the integration of various components within electronic systems. The continued evolution and development of serial communication protocols contribute to the advancement of inter-chip communication and the seamless operation of modern electronic devices.

### BRIEF SUMMARY

In I3C, a controller may initiate a read transaction from a target or a write transaction to a target; in some examples, however, an error may occur when the target believes it is responding to a read transaction, when the controller actually attempted to initiate a write transaction. When this occurs, the write data on the data bus from the controller might conflict with the read data from the target. In I3C, this is referred to as an error type TE6, and the target should stop the transmission, allow the controller to finish the transfer of data, and then wait for a stop or restart condition. It may take several bytes, however, before the stop or restart condition appears.

Example implementations of the present disclosure therefore relate to detection of a stop condition asserted by a target on a serial data bus. The present disclosure includes, without limitation, the following example implementations.

Some example implementations provide a controller comprising: a serial data (SDA) line interface to connect the controller to an SDA line of a two-wire, shared, serial data bus; and a processing circuitry to at least: transfer output data on the SDA line; monitor the SDA line of the two-wire, shared, serial data bus while the output data is transferred on the SDA line of the two-wire, shared, serial data bus; detect a stop condition asserted by a target on the data bus while the output data is transferred on the SDA line of the two-wire, shared, serial data bus; and in response to the detected stop condition, end transfer of the output data on the SDA line.

Some example implementations provide a method comprising: transferring, by a controller, output data on a serial data (SDA) line of a two-wire, shared, serial data bus; monitoring the SDA line of the two-wire, shared, serial data bus while the output data is transferred on the SDA line of the two-wire, shared, serial data bus; detecting a stop condition asserted by a target on the data bus while the output data is transferred on the SDA line of the two-wire, shared, serial data bus; and in response to the detected stop condition, ending transfer of the output data on the SDA line.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a controller according to some example implementations of the present disclosure;

FIG. 2 illustrates a system including the controller of FIG. 1, according to some example implementations;

FIG. 3 illustrates a system that may correspond to the system of FIG. 2, including multiple controllers and targets, according to some example implementations;

FIGS. 4A, 4B and 4C are timing diagrams of signals on lines of a data bus of the system of FIG. 2 or FIG. 3 for a transaction on the data bus, including to specify start, stop and restart conditions (FIG. 4A), an address header (FIG. 4B), and a data word (FIG. 4C), according to some example implementations;

FIGS. 5A and 5B are state diagrams representing a finite state machine of a controller including various states and entry, resume and exit sequences for respectively a private read/write transfer and a directed common command code transfer, according to some example implementations; and

FIGS. 6A and 6B are flowcharts illustrating various steps in a method according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Further, reference may be made herein to terms specific to a particular system or architecture, but it should be understood that example implementations of the present disclosure may be equally applicable to any of a number of systems and architectures. In this regard, some example implementations may be described in the context of serial communication standards for inter-chip communication such as I3C and its predecessor, I2C. It should be understood, however, that example implementations may be equally applicable to other serial communication standards.

Example implementations of the present disclosure relate generally to serial communication and, in particular, to detection and recovery from read-write data conflict on a serial data bus.

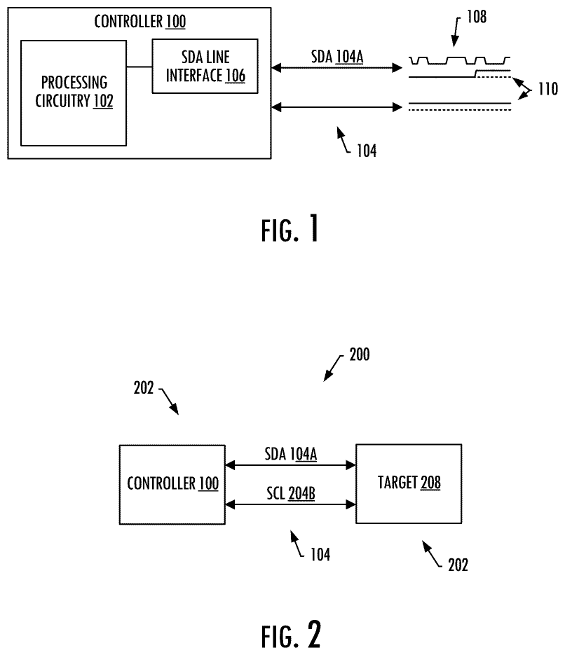

FIG. 1 illustrates a controller 100 according to some example implementations of the present disclosure. The controller 100 may be an electronic device, such as an integrated circuit (IC). The controller 100 includes processing circuitry 102, such as a general or specific-purpose processor, microprocessor, controller, or microcontroller, without limitation. The controller 100 may also include one or more interfaces to connect the controller 100 to a data bus 104 over which the controller 100 may communicate with other electronic devices. In the context of serial communication standards such as I2C and I3C, the data bus may be a two-wire, shared, serial data bus 104. In this regard, the data bus may include a serial data (SDA) line 104A used for transmitting and receiving data between electronic devices connected to the data bus. The controller 100 may include an SDA line interface 106 to connect the controller 100 to the SDA line.

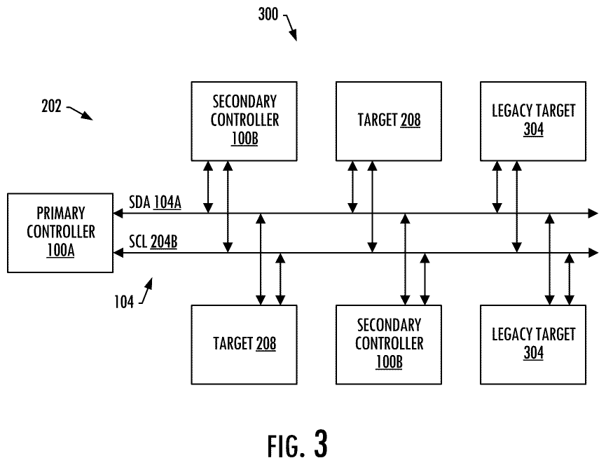

FIG. 2 illustrates a system 200 that includes the controller 100, according to some example implementations of the present disclosure. As shown, the system includes a number of electronic devices 202 such as ICs that are connected to the data bus 104. In addition to the SDA line 104A, the data bus may include a SCL line 204B that provides a clock signal used to synchronize data transfer between the electronic devices 202. In some examples, then, the controller 100 may also include a SCL line interface (not shown) to connect the controller 100 to the SCL line.

The system 200 may operate according to a controller-target architecture in which an electronic device 202 may function as the controller 100 that initiates and controls communication on the data bus 104 (timing and data), and another electronic device may function as a target 208 that responds to commands or requests from the controller 100. In some examples, the system may support multiple controllers and targets.

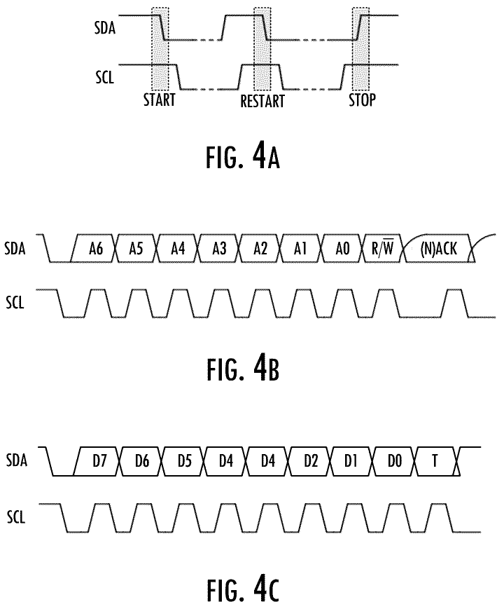

FIG. 3 illustrates a system 300 that may correspond to the system 200 of FIG. 2, including multiple controllers and targets, according to some example implementations. As shown, for example, the system 300 may include a primary controller 100A and one or more secondary controllers 100B, any one of which may be an active controller that is currently in control of the data bus 104. The primary controller may initialize the data bus and perform configuration of targets 208. The primary controller 100A may act as the authority for the data bus in its initial state, and become the first active controller once the data bus is configured. The secondary controller 100B may initially function as a target 208, but the secondary controller 100B can accept controller-ship from the active controller and become the new active controller. In the context of I3C, the system 300 may include an I3C primary controller 100A and one or more I3C secondary controllers 100B.

The system 300 may likewise include one or more targets 208. The system 300 may also include one or more legacy targets 304 from an earlier communication standard with which the system 300 may be compatible. Again, in the context of I3C, the system 300 may include one or more I3C targets 208, and the system may include one or more I2C targets (i.e. legacy targets 304).

Returning to FIG. 2, the system 200 may support multiple data transfer modes, allowing the electronic devices 202 to communicate at different speeds based on their capabilities. The modes may include a single data rate (SDR) mode and a number of high data rate (HDR) modes, with increasing data transfer rates and corresponding signal integrity requirements. The SDR mode in particular may be used for a number of purposes, such as to perform private messaging from the controller 100 to the target 208, and enter other modes and states (e.g., HDR modes). In the context of I3C, the SDR mode may be used to implement built-in I3C features such as common command codes (CCCs), in-band interrupt (IBI), and hot-join. The SDR mode may also be used to transition from I2C to I3C through dynamic address assignment, as well as to perform legacy I2C transactions on the data bus 104.

The electronic devices 202 may operate in various output modes to drive signals on the data bus 104. Examples of suitable modes include an open-drain mode and a push-pull mode, which define how the electronic devices 202 control the voltage levels on the SDA line 104A and the SCL line 204B. In open-drain mode, the electronic device 202 may be configured at its output as an open drain or open collector. In the open-drain mode, the electronic device 202 can pull the signal line (SDA or SCL) to a low voltage level (logic 0) by actively sinking current, but the electronic device 202 is not provided with an active element to pull the signal line to high voltage level (logic 1), instead a pull-up resistor, which may be external, may be used to pull the line to the high voltage level (logic 1). In push-pull mode, the electronic device 202 may be configured at its output as a push-pull driver. In the push-pull mode, the electronic device can actively drive both high (logic 1) and low (logic 0) voltage levels on the signal line.

The electronic devices 202 may implement a number of read/write transactions on the data bus 104. Read transactions may include private read transactions, which involve the controller 100 querying specific data from a particular target 208. Write transactions may encompass both private write and broadcast write transactions. Private write transactions involve targeted communication between the controller 100 and a specific target 208, identified by its unique dynamic or static address, facilitating device-specific commands or configurations. In contrast, broadcast write transactions allow the controller 100 to broadcast data to all electronic devices 202 on the data bus 104, making them suitable for commands or information intended for multiple electronic devices 202.

In addition to private read/write transactions CCC transactions may also be supported. CCC transactions are a specialized category that involves standardized command codes designed for common functionalities shared among different electronic devices 202. CCC transactions may be used for both read and write operations, allowing electronic devices 202 to access and utilize standardized features in a consistent manner. Broadcast write is an example of a CCC transaction. CCC read transactions involve the controller 100 querying a specific CCC, often resulting in the target 208 providing relevant information or responding with the requested data. When the controller 100 initiates a CCC write transaction, the controller 100 sends a specific CCC along with relevant data to a target 208 or to all electronic devices 202 on the data bus 104, depending on the addressing mode (direct or broadcast).

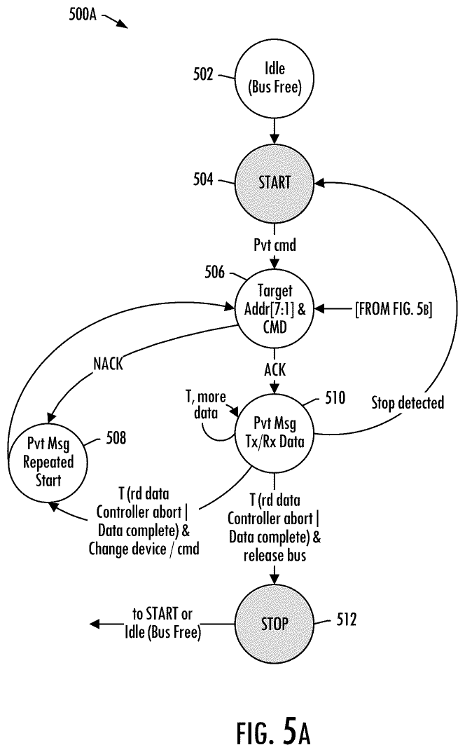

FIGS. 4A, 4B and 4C are timing diagrams of signals on the SDA line 104A and the SCL line 204B for a read/write transaction on the data bus 104, such as a private read/write transaction or a broadcast write transaction, according to some example implementations. As shown in FIG. 4A, read/write transactions on the data bus may begin with a start condition, which may be asserted by the controller 100 and implemented as a high-to-low transition on the SDA line while the SCL line is maintained by the controller 100 at a constant high. Likewise, read/write transactions on the data bus may end with a stop condition asserted by the controller 100 or by the target 208. The controller may implement a stop condition by activating the push-pull mode and driving a low-to-high transition on the SDA line 104A while the SCL line 204B is maintained at a high by the controller 100. The target 208 may implement a stop condition by activating the push-pull mode in the target and driving a low-to-high transition on the SDA line 104A during a high period on the SCL line 204 (which SCL line 204 is controlled by the controller 100). As an alternative to the stop condition, a restart condition may allow multiple messages to be sent in the same frame without needing to transmit a stop and start in between messages. A restart condition may look the same as a start condition on the data bus.

Following a start/restart condition, a private read/write or a broadcast write transaction on the data bus 104 may include an address header, which may include a destination address or broadcast address, indicate a read or write transaction, and provide an acknowledgement. The address header may be transmitted on the SDA line 104A during periods when the SCL line 204B is transitioning from low to high (rising edge) or from high to low (falling edge). FIG. 4B is a timing diagram of the SDA line 104A and the SCL line 204B for an address header (in push-pull mode), according to some example implementations. In the context of I2C and I3C, the address header may include seven address bits [7:1], one read/write (R/W) bit, and one acknowledge (ACK)/non-acknowledge (NACK) bit. In the context of I3C, the R/W bit may be referred to as a R/W bit or a RnW bit. In some examples, the controller 100 may transmit the address and R/W bits. The controller 100 may use the address bits to address the target 208, and the controller 100 may use the R/W bit to specify a write mode (the controller 100 writing data to the target 208) or a read mode (the controller 100 reading data from the target 208). In this regard, the controller 100 may transmit a low signal on SDA line 104A (R/W bit=0) to represent the write mode, or a high signal on SDA line (R/W bit=1) to represent the read mode.

Once the controller 100 transmits the address and R/W bits of the address header on the data bus 104, the controller 100 may wait for the target 208 to acknowledge (or not acknowledge) the request. This may be done through the ACK/NACK bit in the address header. The target 208 may pull the SDA line 104A low (ACK/NACK bit=0) to respond with an acknowledge (ACK), or release the SDA line 104A high (ACK/NACK bit=1) to respond with a non-acknowledge (NACK). In this regard, the SDA line 104A (ACK/NACK) may be sampled at a rising edge of the SCL line 204B.

One or more data words may follow the address header, as shown in FIG. 4C. Similar to the address header, the data words may be transmitted on the SDA line 104A during periods when the SCL line 204B is transitioning from low to high (rising edge) or from high to low (falling edge). In the context of I3C, a data word may be nine bits wide, including eight-bit data and a ninth, transition bit (T-bit). When the controller 100 is writing data to the target 208, the T-bit of each data word may be a parity bit calculated using odd parity, which is helpful in detecting noise-caused errors on the data bus. Conversely, when the controller 100 is reading data returned from the target 208, the T-bit of each data word may represent an end-of-data bit. To end the message, the target 208 may return the T-Bit as ‘0’. To continue the message, the target 208 may return the T-Bit as ‘1’ and monitor the SDA line. If the SDA line remains high on the next falling SCL edge, the target 208 may continue to send the next data value. If the SDA line is low on the next falling SCL edge (restart), then the controller 100 has aborted the data transfer, and the target 208 does not send the next data.

The electronic devices 202 may implement one or more error detection and recovery methods to handle various error conditions during read/write transactions on the data bus 104. In this regard, in the context of I3C, if an error occurs in the R/W bit of the address header, the target 208 might believe that it is responding to a private read transaction, when the controller 100 actually attempted to initiate a private write transaction. When this occurs, the write data on the data bus from the controller 100 might conflict with the read data from the target 208. In the MIPI I3® Specification, published by the Mobile Industry Processor Interface (MIPI) Alliance, this error condition is referred to as error type TE6. As specified, the target 208 should monitor data the target 208 transmits on the SDA line 104A of the data bus 104 for read transactions, and the target 208 is to detect a TE6 error condition when the monitored data differs from the data the target 208 intended to transmit.

According to MIPI I3® Specification, when the target 208 detects a TE6 error condition during an attempted private write transaction with the controller 100 (i.e., when the target 208 acts as it is responding to a private read transaction while the controller 100 has attempted to perform a private write transaction), the target 208 may stop the transmission, allow the controller 100 to finish the transfer of data, and then wait for a stop or restart condition. It may take several bytes, however, before the stop or restart condition appears on the SDA line 104A, in some cases up to 68 bytes. Example implementations of the present disclosure therefore provide an improved error detection and recovery method for a TE6 error condition, which may avoid prolonged conflicting data on the data bus 104 and reduce power consumption.

The target 208 may operate in a read state to execute a perceived read transaction to transfer output data on to the data bus 104. When the target is in the read state, the target may monitor data on the SDA line 104A, compare the data on the SDA line 104A with the output data, and detect an error condition when the data on the SDA line 104A and the output data differ. To recover from the error condition, then, the target may disable an internal, output SDA pad buffer that drives the output data on the SDA line, until a stop or restart condition appears on the SDA line, indicating that transfer of the data from the controller 100, which is competing with, and interfering with, the output data, is complete. Additionally or alternatively, in some examples, the target 208 may assert a stop on the data bus 104, which the controller 100 may detect and end transfer from the controller 100 on to the SDA line. In some examples, the target 208 may assert a stop on the data bus by driving a low-to-high transition on the SDA line 104A during a high period on the SCL line 204 (which SCL line 204 is controlled by the controller 100).

As shown in FIG. 1, for example, the processing circuitry 102 of the controller 100 may transfer output data 108 on the SDA line 104A, such as to a target 208. The processing circuitry 102 may monitor the data bus 104 while the output data 108 is transferred on the SDA line 104A. In examples where data bus 104 includes the SDA line 104A and the SCL line 204B, the processing circuitry 102 may monitor the SDA line 104A, since the SCL line 204B is exclusively driven by the controller 100. In some examples, the processing circuitry 102 may monitor data bus 104 while the controller is in a write state to execute a private write transaction to transfer the output data 108 to the target. In other examples, the processing circuitry 102 may monitor the data bus 104 while the controller is in a write or command state to execute a CCC write or direct CCC command transaction to transfer the output data 108 to the target.

The processing circuitry 102 of the controller 100 may detect a stop condition 110 asserted by a target 208 on the data bus 104 while the output data 108 is transferred on the SDA line 104A. In examples including the SDA line 104A and the SCL line 204B, this may include the processing circuitry 102 to detect a low-to-high transition of a voltage level on the SDA line 104A, during a high period of a voltage level on the SCL line. In response to the detected stop condition 110, then, the processing circuitry 102 may end transfer of the output data 108 on the SDA line 104A. As explained above, the stop condition 110 may be based on an error condition detected at the target 208. In this regard, the error condition may be characterized by transfer of the data on to the SDA line 104A by the target 208 while the output data 108 is transferred on the SDA line 104A.

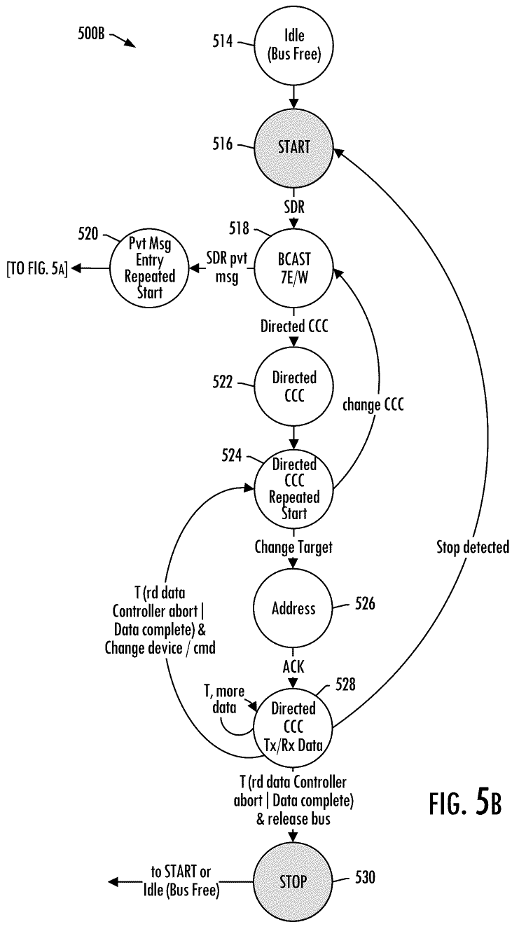

To further illustrate some example implementations, FIGS. 5A and 5B are state diagrams, representing a finite state machine of a controller 100 including various states and entry, resume and exit sequences for respectively a private R/W transfer 500A, as shown in FIG. 5A, and a directed CCC transfer 500B, as shown in FIG. 5B. The controller 100 may operate in a write or command state to execute a CCC write or direct CCC command transaction. In some examples, the data bus 104 may have various timing conditions used to create permission for the controller 100 or a target 208 to take a defined action leading to a start condition. These timing conditions include a bus free condition; and as shown, a bus idle condition 502. In this regard, the bus idle condition 502 is a period during which the bus free condition is sustained continuously for at least a predefined duration.

In FIG. 5A for a private R/W transfer 500A, the controller 100 may assert a start condition 504 (see also FIG. 4A) on the idled data bus 104, followed by an address header 506 (see also FIG. 4B) including a target address (e.g., in bits [7:1]) and a private R/W command. The target 208 may respond with an acknowledgement (ACK) or non-acknowledgement (NACK). If the target responds with a NACK, the controller 100 may assert a private message repeated start condition 508, and repeat the address header 506. If the target responds with an ACK, the controller 100 may next receive one or more data words 510 (see also FIG. 4A) from the target 208 (for a private read), or transfer one or more data words to the target 208 (for a private write). The controller 100 at this time may also monitor the data bus 104 to detect a stop condition asserted by the target 208, as described above.

In particular, as explained above, in the case of a private write, the controller 100 may operate in a write state to execute a private write transaction to transfer output data (data to the target 208). The controller 100 may monitor the data bus 104, particularly the SDA line 104A. In examples in which the target 208 detects an error condition (e.g., TE6 error condition), the target 208 may assert a stop on the SDA line 104A when the SCL line is high. The controller 100 may detect the stop and end its transfer of the one or more data words to the target. In some examples, the controller 100 may return to and again assert a start condition 504, and either repeat the transfer or schedule a next transfer of output data.

As also shown, in the case of a private read or private write, in condition 510, the controller 100 may when expected or writing more data, may after the T bit continue with more data. If additional commands are pending and the transaction has completed in condition 510, or the controller has determined to abort the transaction, the controller may proceed to condition 508, where it may change the target 208 or command. If additional commands are not pending and the transaction has completed in condition 510, or the controller has determined to abort the transaction, the controller may proceed to condition 512, and release the bus.

As shown in FIG. 5B for a directed CCC transfer 500B, the data bus 104 may be in the bus idle condition 514, and the controller 100 may assert a start condition 516 on the idled data bus 104. In single data rate (SDR) mode, the controller may assert an address header 518 including a broadcast address (Hex 7E) and a write (W) command. The controller 100 may enter an SDR private R/W with a repeated start condition 520, which (returning to FIG. 5A) may be followed by an address header 506 including a target address (e.g., in bits [7:1]) and a private R/W command, as described above in relation to FIG. 5A. In other cases, the controller 100 may assert a directed CCC 522, which may be followed by a directed CCC repeated start condition 524 to change the CCC (and reassert the address header 518), or change the target and the corresponding target address 526.

Following an acknowledge (ACK) from the target 208, depending on the directed CCC, the controller 100 may next receive one or more data words 528 from the target 208, or transfer one or more data words to the target 208. Until the data is complete, upon the T bit, condition 528 may be reasserted until data is complete. The controller 100 at this time may also monitor the data bus 104 to detect a stop condition asserted by the target 208, as described above. In particular, for a directed CCC transfer, the controller 100 may operate in a write or command state to execute a CCC write or direct CCC command transaction to transfer output data (data to the target 208). Similar to above, the controller 100 may monitor the data bus 104, and detect a stop asserted by the target 208 based on an error condition detected at the target 208. The controller 100 may detect the stop asserted by the target 208 and end its transfer of output data. The controller 100 may then return to and again assert a start condition 516, and either repeat the transfer or schedule a next transfer of output data.

In a case where the controller 100 is reading data from the target 208, the controller 100 may abort the read or allow the read to continue until complete. If additional commands are pending and the transaction has completed in condition 528, or the controller has determined to abort the transaction, the controller may proceed to condition 524, where it may change the target 208 or command. If additional commands are not pending and the transaction has completed in condition 528, or the controller has determined to abort the transaction, the controller may proceed to condition 530, where the controller may release the bus.

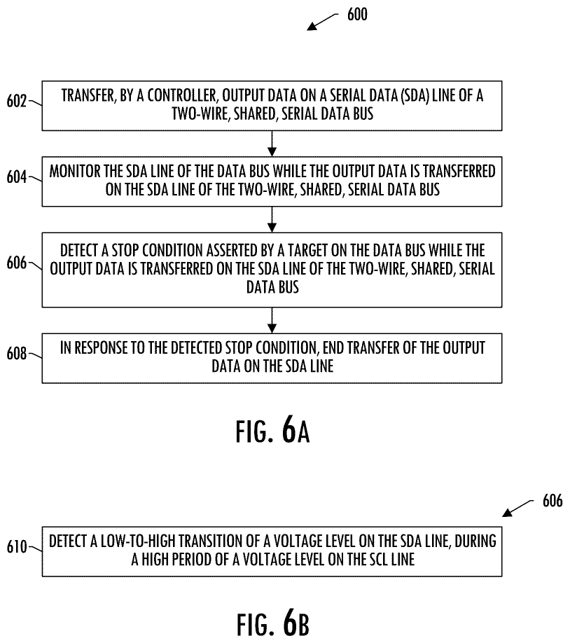

FIGS. 6A and 6B are flowcharts illustrating various steps in a method 600 according to various example implementations. The method includes transferring, by a controller, output data on a serial data (SDA) line of a two-wire, shared, serial data bus, as shown at block 602 of FIG. 6A. The method includes monitoring the SDA line of the data bus while the output data is transferred on the SDA line of the two-wire, shared, serial data bus, as shown at block 604. The method includes detecting a stop condition asserted by a target on the data bus while the output data is transferred on the SDA line of the two-wire, shared, serial data bus, as shown at block 606. The method includes, in response to the detected stop condition, ending transfer of the output data on the SDA line, as shown at block 608.

In some examples, the data bus includes the SDA line and a serial clock (SCL) line. In some of these examples, detecting the stop condition at block 606 includes detecting a low-to-high transition of a voltage level on the SDA line, during a high period of a voltage level on the SCL line, as shown at block 610 of FIG. 6B.

In some examples, the output data is transferred to the target, from the controller, at block 602.

In some examples, the data bus is monitored at block 604 by the controller in a write state to execute a private write transaction to transfer the output data to the target.

In some examples, the data bus is monitored at block 604 by the controller in a write or command state to execute a common command code (CCC) write or direct CCC command transaction to transfer the output data to the target.

In some examples, the stop condition is based on an error condition detected at the target. In this regard, the error condition may be characterized by transfer of the data on to the SDA line by the target while the output data is transferred on the SDA line by the controller.

As explained above and reiterated below, the present disclosure includes, without limitation, the following example implementations.

Clause 1. A controller comprising: a serial data (SDA) line interface to connect the controller to an SDA line of a two-wire, shared, serial data bus; and a processing circuitry to at least: transfer output data on the SDA line; monitor the SDA line of the two-wire, shared, serial data bus while the output data is transferred on the SDA line of the two-wire, shared, serial data bus; detect a stop condition asserted by a target on the data bus while the output data is transferred on the SDA line of the two-wire, shared, serial data bus; and in response to the detected stop condition, end transfer of the output data on the SDA line.

Clause 2. The controller of clause 1, wherein the data bus includes the SDA line and a serial clock (SCL) line, and wherein the processing circuitry to detect the stop condition includes the processing circuitry to detect a low-to-high transition of a voltage level on the SDA line, during a high period of a voltage level on the SCL line.

Clause 3. The controller of clause 1 or clause 2, wherein the processing circuitry is to transfer the output data to the target.

Clause 4. The controller of clause 3, wherein the processing circuitry is to monitor the data bus while the controller is in a private write state to execute a private write transaction to transfer the output data to the target.

Clause 5. The controller of clause 3 or clause 4, wherein the processing circuitry is to monitor the data bus while the controller is in a private write state or a common command state.

Clause 6. The controller of any of clauses 3 to 5, wherein the stop condition is based on an error condition detected at the target.

Clause 7. The controller of clause 6, wherein the error condition is characterized by transfer of the data on to the SDA line by the target while the output data is transferred on the SDA line by the controller.

Clause 8. A method comprising: transferring, by a controller, output data on a serial data (SDA) line of a two-wire, shared, serial data bus; monitoring the SDA line of the two-wire, shared, serial data bus while the output data is transferred on the SDA line of the two-wire, shared, serial data bus; detecting a stop condition asserted by a target on the data bus while the output data is transferred on the SDA line of the two-wire, shared, serial data bus; and in response to the detected stop condition, ending transfer of the output data on the SDA line.

Clause 9. The method of clause 8, wherein the data bus includes the SDA line and a serial clock (SCL) line, and wherein detecting the stop condition includes detecting a low-to-high transition of a voltage level on the SDA line, during a high period of a voltage level on the SCL line.

Clause 10. The method of clause 8 or clause 9, wherein the output data is transferred to the target.

Clause 11. The method of clause 10, wherein the data bus is monitored by the controller in a private write state to execute a private write transaction to transfer the output data to the target.

Clause 12. The method of clause 10 or clause 11, wherein the data bus is monitored by the controller in a private write state or a common command state.

Clause 13. The method of any of clauses 10 to 12, wherein the stop condition is based on an error condition detected at the target.

Clause 14. The method of clause 13, wherein the error condition is characterized by transfer of the data on to the SDA line by the target while the output data is transferred on the SDA line.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A controller comprising:
a serial data (SDA) line interface to connect the controller to an SDA line of a two-wire, shared, serial data bus; and
a processing circuitry to at least:
transfer output data on the SDA line;
monitor the SDA line of the two-wire, shared, serial data bus while the output data is transferred on the SDA line of the two-wire, shared, serial data bus;
detect a stop condition asserted by a target on the data bus while the output data is transferred on the SDA line of the two-wire, shared, serial data bus; and in response to the detected stop condition,
end transfer of the output data on the SDA line.

2. The controller of claim 1, wherein the data bus includes the SDA line and a serial clock (SCL) line, and wherein the processing circuitry to detect the stop condition includes the processing circuitry to detect a low-to-high transition of a voltage level on the SDA line, during a high period of a voltage level on the SCL line.

3. The controller of claim 1, wherein the processing circuitry is to transfer the output data to the target.

4. The controller of claim 3, wherein the processing circuitry is to monitor the data bus while the controller is in a private write state to execute a private write transaction to transfer the output data to the target.

5. The controller of claim 3, wherein the processing circuitry is to monitor the data bus while the controller is in a private write state or a common command state.

6. The controller of claim 3, wherein the stop condition is based on an error condition detected at the target.

7. The controller of claim 6, wherein the error condition is characterized by transfer of the data on to the SDA line by the target while the output data is transferred on the SDA line by the controller.

8. A method comprising:
transferring, by a controller, output data on a serial data (SDA) line of a two-wire, shared, serial data bus;
monitoring the SDA line of the two-wire, shared, serial data bus while the output data is transferred on the SDA line of the two-wire, shared, serial data bus;
detecting a stop condition asserted by a target on the data bus while the output data is transferred on the SDA line of the two-wire, shared, serial data bus; and in response to the detected stop condition,
ending transfer of the output data on the SDA line.

9. The method of claim 8, wherein the data bus includes the SDA line and a serial clock (SCL) line, and wherein detecting the stop condition includes detecting a low-to-high transition of a voltage level on the SDA line, during a high period of a voltage level on the SCL line.

10. The method of claim 8, wherein the output data is transferred to the target.

11. The method of claim 10, wherein the data bus is monitored by the controller in a private write state to execute a private write transaction to transfer the output data to the target.

12. The method of claim 10, wherein the data bus is monitored by the controller in a private write state or a common command state.

13. The method of claim 10, wherein the stop condition is based on an error condition detected at the target.

14. The method of claim 13, wherein the error condition is characterized by transfer of the data on to the SDA line by the target while the output data is transferred on the SDA line.
